(19) United States
(12) Patent Application Publication
(10) Pub. No.: US 2013/0149058 A1
(43) Pub. Date: Jun. 13, 2013

(54) Undercutting Tool

(71) Applicant: Pat Kelly, North Sydney (AU)

(72) Inventor: Pat Kelly, North Sydney (AU)

(21) Appl. No.: 13/695,046

(22) PCT Filed: May 5, 2011
(86) PCT No.: PCT/AU2011/000522

§ 371 Date: Feb. 21, 2013

(30) Foreign Application Priority Data
May 7, 2010 (AU) 2010901964

(51) Int. Cl. B23B 51/00

(52) U.S. Cl. CPC B23B 51/0045
USPC 408/147

(57) ABSTRACT

An undercutting tool for producing an undercut in a bore, the undercutting tool comprising a tool body, which can be at least partially inserted into the bore that is to be undercut, at least one wedge moveably attached to the tool body and at least one cutting surface. The at least one wedge is displaced outwardly by centrifugal force due to rotation of the undercutting tool. The at least one cutting surface is adapted to cut into the bore that is to be undercut as the at least one wedge is displaced outwardly.

### FIELD OF THE INVENTION

The present invention relates to an undercutting tool. In some embodiments, the invention is directed to an undercutting tool for producing undercuts in pilot bores in concrete, cement, rock and the like, although the scope of the invention is not necessarily limited thereto.

### BACKGROUND

Undercutting tools are available in the marketplace and are used to produce undercuts in bore walls of concrete and the like.

Existing undercutting tools are Complex and usually have a lot of moving parts to be able to adequately. undercut a bore by forcing the cutting part against the bore wall. For example U.S. Pat. No. 4,502,544 discloses a rotary power tool for reaming frusto-conical undercuts into cylindrical holes by forcing cutting blades outwardly using a ram, to undercut the wall of the hole.

A problem with existing undercutting tools is that the time taken to undercut a hole can be relatively long, as some of the tools requite constant re-adjustment by an operator.

In some instances the undercutting tools use off-centre rotation to achieve an Undercut. The problem with these undercutting tools is that they require specialised adapters to align the undercutting tool with the bore to be undercut.

Another disadvantage with existing undercutting tools is that the complex mechanisms used to force the cutting part against the bore wall have to be disengaged before the tool can be removed from the bore hole, which is time consuming and in some instances can lead to tools becoming stuck in the bore. Safety is also a great concern with existing undercutting tools, with many operators leaving the tool attached to the drill while the tool is being adjusted. Accidental activation of the drill in these circumstances can lead to serious injuries.

It is an aim of the invention to provide an undercutting tool which overcomes or ameliorates one or more of the disadvantages or problems described above, or which at least provides the consumer with a useful choice.

It will be clearly understood that any reference herein to background material or information, or to a prior publication, does not constitute an admission that any material, information or publication forms part of the common general knowledge in the art, or is otherwise admissible prior art, whether in Australia or in any other country.

### DESCRIPTION OF THE INVENTION

According to a first embodiment of the invention, there is provided an undercutting tool for producing an undercut in a bore, the undercutting tool comprising a tool body, which can be at least partially inserted into the bore that is to be undercut, at least one wedge moveably attached to the tool body such that the at least one wedge is displaced outwardly by centrifugal force when the undercutting tool is sufficiently rotated, and at least one cutting surface that is displaced outwardly as the at least one wedge is displaced outwardly and is adapted to cut into the bore that is to be undercut.

Reference to “wedges” herein can also refer to one wedge. Reference to “cutting surfaces” herein can also refer to one cutting surface.

In one embodiment, the tool body may be adapted to connect to a shaft. Normally the tool body will have a threaded portion to attach to a corresponding threaded part on the shall. The tool body may be bolted, coupled, fixed, held, locked, mounted, secured, welded and/or have any suitable type of attachment Means to the shaft. The shaft may be attached to a drill, cutting Machine or the like. Alternatively, the tool body may be adapted to attach to a drill, cutting machine or the like. The tool body is normally made Of a suitable metallic material. Alternatively the tool body may be made from an alloy, polymer, ceramic, composite and/or any material according to a suitable materials selection chart. The tool body may have one or more connection points to allow one or more wedges to be attached to the tool body.

The tool body is normally substantially cylindrical in shape. Alternatively the tool body may have a shape that is substantially annular, conical, elliptical, oval, rectangular, round, square, triangular, a polygon in cross section and/or the like. The undercutting tool should be able to rotate in the bore that is to be undercut. The tool body is normally at least partially tubular. Alternatively the tool body may be substantially solid. The tool body may have one or more connection points to enable Wedges to be attached to the tool body. The connection points may be holes, threaded bores, slots, openings and/or the like in the tool body. Alternatively the connection points may be arms, fingers, coupling members, supports, projections and/or the like on the tool body.

In one embodiment, the wedges may be replaceable. The Wedges may be restricted from excess pivoting, sliding, bending and/or the like so that the wedges only extend to a desired amount. Normally the wedges are restricted from excess pivoting, sliding, bending and/or the like by part of the tool body abutting the wedges and/or connecting portions of the wedges once the wedges have extended the desired amount. Alternatively the tool body may have projections that are adapted to restrict the wedges from excess pivoting, sliding, bending and/or the like. The projections may be adjustable to adjust the amount that the wedges can extend.

The extension of the wedges may also be controlled by controlling the speed of rotation, here the centrifugal forces act against the gravitational forces on the wedges and the wedges extend as the rotation is increased. Normally, when the undercutting tool is not rotating and in an upright position (i.e. the wedges are at the lower end of the tool) and there are no other forces acting on the wedges, the wedges will be in a retracted position due to the wedges being able to pivot, slide, bend and/or the like, and due to the lack of centrifugal forces biasing the wedges outwardly and/or the Weight of the wedges (i.e. gravitational forces biasing the wedges downwardly), this retracted position allows the undercutting tool to be lowered into a bore. The wedges may also be biased into the retracted position by springs when the tool is not rotating, this may aid insertion of the tool into a bore.

The wedges are normally made of a suitable hard metallic material. Alternatively the wedges may be made from an alloy, polymer, ceramic, composite and/or any material according to a suitable materials selection chart.

In one embodiment, the wedges may have one or more connecting portions. The one or more connecting portions on the wedges may be connected to one or more connection points on the tool body. Normally the connecting portions and connection points are connected using, a connecting member such as a pin, split pin, bolt, cable clamp, coupling, dowel, hook, keeper, rivet, screw, fastener and/or the like. Alternatively the wedges and the tool body can be connected together using a captive arrangement, sliding joint, hinge, flexible material, welding and/or the like. Preferably once connected, the wedges can still move, for example pivot, slide, bend and/or the like relative to the body. The advantage of having individual wedges is that they can be replaced. The connection points, connecting portions and/or connecting member are normally of sufficient size and strength to overcome any forces that are encountered.

In another embodiment, the wedges may be integrally formed with the tool body. The material of the tool body and the wedges may be flexible enough to allow the wedges to expand. Alternatively, the material between the wedges and the tool body may be sufficiently flexible to allow the wedges to expand. The wedges may have a shaped section between the Wedges and the tool body which allows the wedges to expand whilst still providing sufficient strength. The shaped section between the wedges and the tool body may be narrower than the wedges.

In one embodiment, the cutting surfaces may include one or more abrasive pads. Normally, the cutting surfaces are diamond abrasive pads. The cutting surfaces may be tungsten pads. The cutting surfaces may be made from abrasive material such as mineral abrasives, stone abrasives, metal abrasives, natural abrasives, synthetic abrasives, bonded abrasives, coated abrasives and/or the like. Alternatively the cutting surfaces may be made from a hardened material such as a metal, alloy, ceramic and/or any material according to a suitable materials selection chart. The cutting surfaces may have serrations, projections, sharp edges, work hardened edges and/or the like. The cutting surface may be heat, treated and/or hardfaced.

In one embodiment, the cutting surfaces may be attached to the wedges. The cutting surfaces may be bonded, brazed, welded, clamped, glued, fastened and/or the like on to the wedges. Alternatively the cutting surfaces may be retained by the wedges.

In another embodiment, the cutting surfaces may be integrally formed as part of the wedges. The wedges May be shaped to provide cutting surfaces. The wedges may be adapted to be cutting surfaces. The wedges may be the cutting surfaces. The wedges may be made from abrasive material such as mineral abrasives, stone abrasives, metal abrasives, natural abrasives, synthetic abrasives, bonded abrasives, coated abrasives and/or the like. Alternatively the wedges may be made from a hardened material such as a metal, alloy, ceramic and/or any material according to a suitable materials selection chart. The wedges may have serrations, projections, sharp edges, work hardened edges and/or the like. The wedges may be heat treated and/or hardfaced.

In one embodiment, the centrifugal forces acting on the wedges and/or the cutting surfaces when the undercutting tool is rotating, displace the wedges and/or cutting surfaces outwardly. An increase in rotational speed will increase the centrifugal forces. Normally, the angle between the wedges and the tool body increases as the wedges are displaced due to increasing centrifugal forces. The angle between the wedges and the tool body is normally. Close to 0 degrees at rest. Alternatively the angle between the tool body and the wedges may be closer to 180 degrees at rest and the angle between the wedges and the tool body decreases as the wedges are displaced due to increasing centrifugal forces. Preferably, the undercutting tool is rotated at a speed to provide sufficient centrifugal force to displace the wedges outwardly with sufficient force to form the undercut. The undercut formed by the undercutting tool will normally be of a frusto-conical shape due to the manner in which the wedges and/or cutting surfaces are displaced outwardly.

The undercutting tool of the present invention may be used to undercut materials such as concrete, cement, rock, plastics, polymers, ceramics, masonry, wood, metals, bone, glass, composites, rubber and/or the like.

The undercutting tool of the present invention may be used with a drill, hand drill, larger drill, larger rig, cutting machine, machining tool and/or the like. The drill, rig, machine or the like may be attached to the structure that is to be cut and/or may otherwise be supported to resist the torque created by cutting.

The undercutting tool of the present invention may be of any suitable size. The undercutting tool is normally relatively large compared to drill bits that fit a standard drill, as the centrifugal forces have to be sufficient to cut the material to be undercut. However, the undercutting tool may also be of a smaller size, in this case, the rotational speed of the undercutting tool may need to be increased to provide sufficient centrifugal force.

The undercutting tool of the present invention may be controlled using any suitable control method to adjust the speed of rotation of the undercutting tool in order to control the angle of the wedges and/or the centrifugal force.

Some benefits of the undercutting tool of the present invention include the following:
1. Reduced costs;
2. Durability;
3. Less Moving parts;
4. Construction simplification;
5. Ease of assembly;
6. Safer Operation; and
7. Ability to operate under most conditions.

### BRIEF DESCRIPTION OF THE DRAWINGS

One or more preferred embodiments of the invention will now be described, by way of example only, with reference to the accompanying drawings in which:

FIG. 1 is a view of an undercutting tool.

FIG. 2 is a view of an undercutting tool connected to a shaft.

FIG. 3 is a view of an undercutting tool with wedges in a retracted position.

FIG. 4 is an underneath view of an undercutting tool.

FIG. 5 is a view of an undercutting tool with wedges in a displaced position.

FIG. 6 is a View of a shaft adapted to attach to the undercutting tool.

### BEST MODE

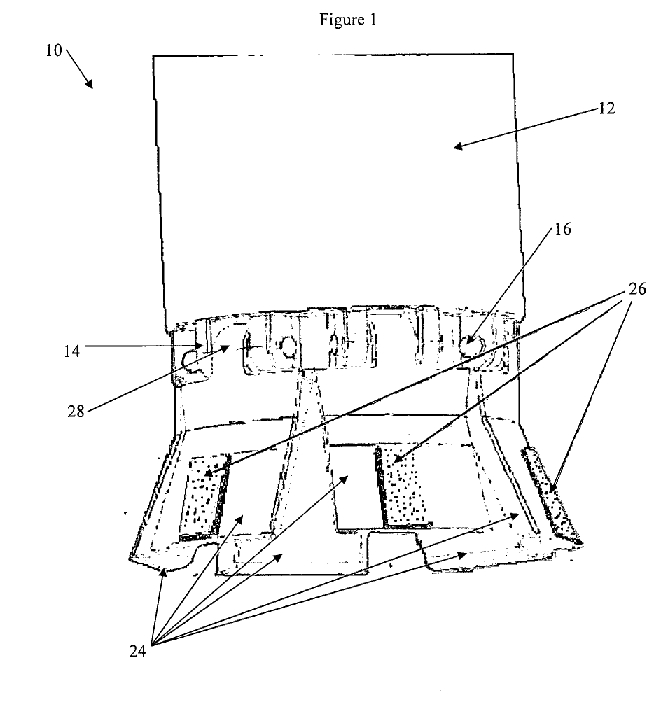

With reference to FIG. 1,, there is shown an Undercutting tool 10 having a tool body 12 and connected to six wedges 12. The connection points 14 on the tool body 12 are attached to the connecting portions 28 of the wedges 12 by connecting members 16. The connecting members 16 are slightly deformed at the ends to prevent them from coming lose from the connection points 14. Cutting surfaces 26 are attached to the wedges 12.

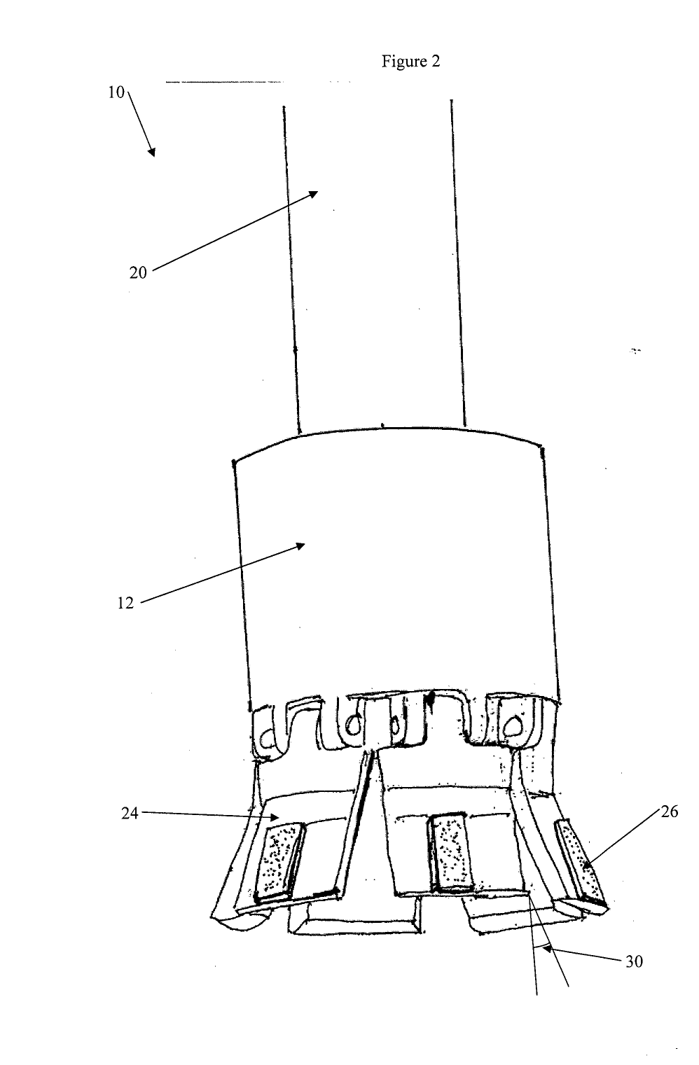

FIG. 2 shows an undercutting tool 10 attached to a shaft 20 as the undercutting tool 10 rotates, the wedges 24 are breed outward increasing the angle 30 between the tool body 12 and the wedges 24. The angle 30 of the wedges 24 as shown in FIG. 2 would be equivalent to a medium rotational speed of the undercutting tool. Normally the undercutting tool 10 would be attached to a drill or the like (not shown) and lowered into a bore (pet shown), the wedges 24 would be in a contracted position allowing the undercutting tool 10 to be lowered into the bore. Once in position, the undercutting tool 10 be rotated, causing the wedges 24 to be displaced outwardly due to the centrifugal forces, causing the cutting surfaces 26 to cut into the wall of the bore (not shown) The speed of the undercutting tool would be controlled to ensure that the wedges 24 are displaced outwardly to a sufficient angle. After the bore has been undercut, the wedges 24 will be At a desired angle and rotating freely. Once the undercutting tool has stopped rotating, the wedges will be in the retracted position and the tool can be removed from the undercut bore. The wedges 24 are normally at an angle close to 0 degrees at rest, this angle then increases as the undercutting tool 10 is rotated.

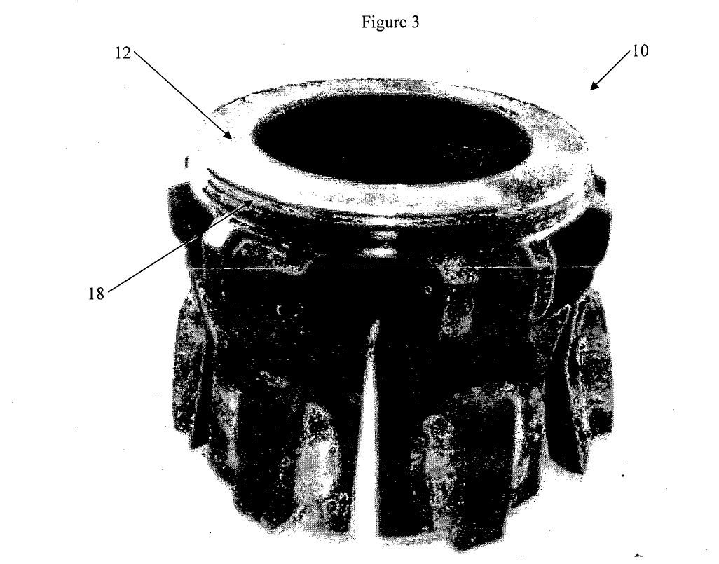

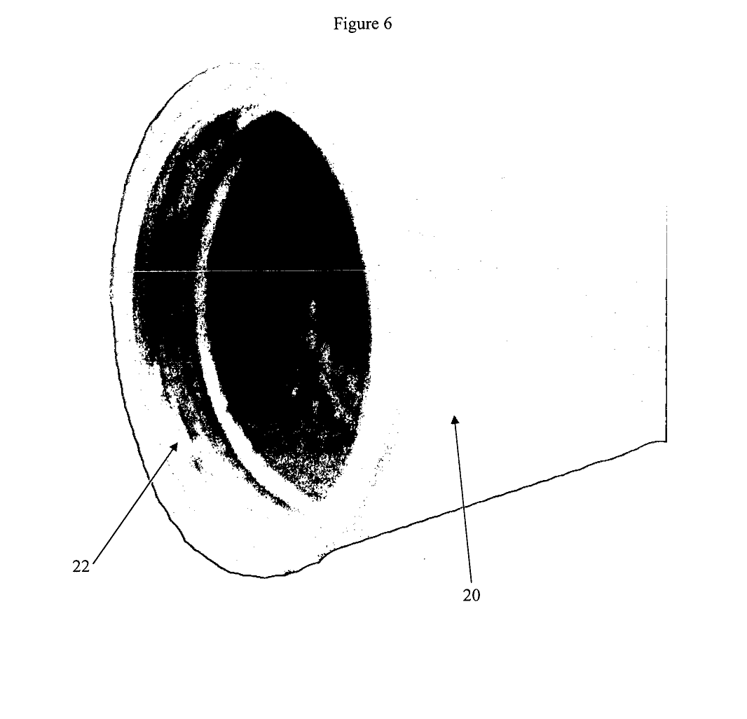

FIG. 3 shows an undercutting tool 10 with a threaded portion 18. The threaded portion 18 enables the undercutting, tool to be attached to a shaft 20 (as shown in FIG. 6) which has a corresponding threaded bore 22 (as shown in FIG. 6). The wedges 24 are in a partially retracted position.

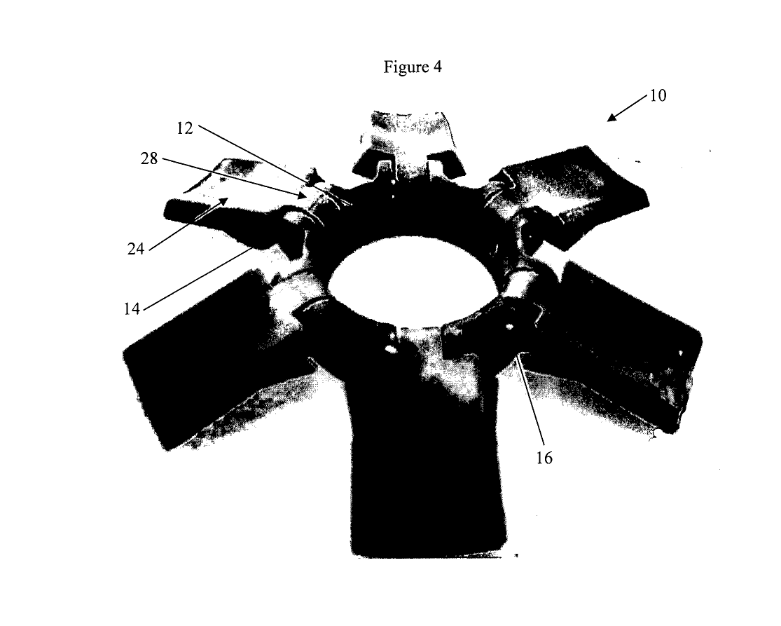

FIG. 4 shows an undercutting tool 10 with wedges 24 pivotably attached to the tool body 12. The connecting portions 28 of the wedges 24 are attached to the connection points 14 of the tool body 12 by connecting members 16.

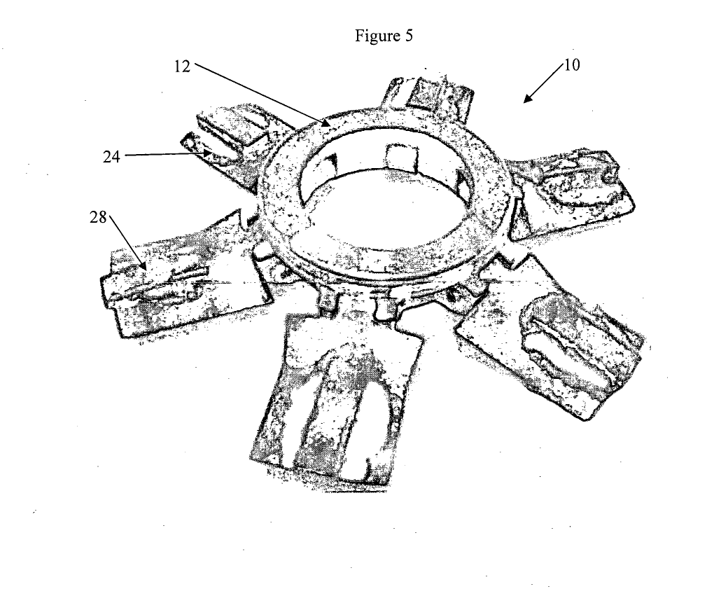

FIG. 5 shows an undercutting tool 10 with cutting surfaces welded onto the wedges 24. The wedges 24 which are pivotably attached to the tool body 12. The wedges 24 are in an outwardly displaced position.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection With the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An undercutting tool for producing an undercut in a bore, the undercutting tool comprising:
a tool body, which can be at least partially inserted into the bore that is to be undercut;
at least one wedge moveably attached to the tool body; and
at least one cutting surface; where the at least one wedge is displaced outwardly by centrifugal force due to rotation of the undercutting tool and wherein the at least one cutting surface is adapted to cut into the bore that is to be undercut as the at least one wedge is displaced outwardly.

2. An undercutting tool as claimed in claim 1, wherein the at least one wedge is pivotably attached to the tool body.

3. An undercutting tool as claimed in claim 1, wherein the at least one wedge is integrally formed with the tool body.

4. An undercutting tool as claimed in claim 1, wherein the at least one wedge is slideably attached to the tool body.

5. An undercutting tool as claimed in claim 1, wherein the at least one wedge is attached to the tool body by flexible material.

6. An undercutting tool as claimed in claim 1, wherein the at least one wedge is attached to a lower end of the tool body.

7. An undercutting tool as claimed in claim 1, wherein the at least one cutting surface is part of at least one of the at least one wedge.

8. An undercutting tool as claimed in claim 1, wherein the at least one cutting surface is attached to at least one of the at least one wedge.

9. An undercutting tool as claimed in claim 1, wherein the undercutting tool has two or more wedges.

10. An undercutting tool as claimed in claim 1, wherein the undercutting tool is adapted to form a substantially frusto-conical undercut in the bore.

11. An undercutting tool as claimed in claim 1, wherein the at least one wedge and/or parts thereof abuts the undercutting tool and/or parts thereof once a desired outwardly displacement of the at least one-wedge is achieved, to prevent excess undercutting of the bore.

12. An undercutting tool as claimed in claim 1, wherein the undercutting tool is adapted to attach to a drill, hand drill, larger drill, larger rig, cutting machine, and/or a machining tool.

13. (canceled)

14. An undercutting tool as claimed in claim 2, wherein the at least one wedge is attached to a lower end of the tool body.

15. An undercutting tool as claimed in claim 2, wherein the at least one cutting surface is attached to at least one of the at least one wedge.

16. An undercutting tool as claimed in claim 2, wherein the at least one cutting surface is part of at least one of the at least one wedge.

17. An undercutting tool as claimed in claim 3, wherein the at least one wedge is attached to the tool body by flexible material.

18. An undercutting tool as claimed in claim 3, wherein the at least one cutting surface is part of at least one of the at least one wedge.

19. An undercutting tool as claimed in claim 3, wherein the at least one cutting surface is attached to at least one of the at least one wedge.

20. An undercutting tool as claimed in claim 4, wherein the at least one cutting surface is attached to at least one of the at least one wedge.

21. An undercutting tool as claimed in claim 4, wherein the at least one wedge is attached to a lower end of the tool body.
